(19) United States
(12) Patent Application Publication
(10) Pub. No.: US 2022/0394073 A1
(43) Pub. Date: Dec. 8, 2022

(54) METHOD AND APPARATUS FOR DETERMINING BITRATE SWITCH POINTS

(71) Applicant: Comcast Cable Communications, LLC, Philadelphia, PA (US)

(72) Inventors: Michael Burke, Aurora, CO (US); Caleb Smith, Denver, CO (US)

(21) Appl. No.: 17/341,698

(22) Filed: Jun. 8, 2021

(51) Int. Cl. H04L 29/06; H04L 12/26

(52) U.S. Cl. CPC H04L 65/607; H04L 65/601; H04L 43/106; H04L 43/0894

(57) ABSTRACT

Systems and methods are described herein for processing, transmitting and presenting content, such as video content. A computing device playing back content may determine the best opportunities to shift versions or variants of the content that is encoded at different bitrates by shifting at switch points that may have been incorporated into the content stream or associated data. The computing device may determine that network conditions have changed and may then wait to detect a switch point in the content before shifting the bitrate of the content stream. The switch point may be associated with a low action point or a dark point in a scene within the content, or may relate to points in the content that are less likely to interrupt the viewing experience of a user. The computing device may also receive messages such as alerts or notifications at the switch point.

### BACKGROUND

Video playback devices may monitor conditions such as its network quality and the amount of content buffered when streaming. When a video playback device changes the bit rate of a streamed video, the video playback device may immediately shift bit rates. But, such immediate shifting may result in a disruption in the viewing experience for users. Accordingly, there is a need for improved techniques for the timing of switching between video streams.

### SUMMARY

Systems and methods are described herein for processing content such as video content. A computing device playing back content may determine the best opportunities to shift versions or variants of the content, which are encoded at different bitrates. The computing device may determine that network conditions would support a higher bitrate and may then wait to detect a switch point in the content before shifting to the higher bitrate content stream. The switch point may be identified by an encoded location in the content or by data associated with the content. For example, the switch point may be communicated through in-band and/or out of band timed metadata, which may include timing information. For example, the switch point may be indicated by a tag inserted in the encoded content. The switch point may be associated with a low action point or a dark point in a scene within the content. The low action point may indicate a point within the scene with a low quantity of movement. The low action point may indicate a scene change. The dark point may indicate a point within the scene with dim coloring. If network conditions deteriorate or become more congested, the computing device may determine that a lower bitrate is needed and may then wait to detect a switch point in the content before shifting to the lower bitrate content stream. The content streams may be variants in an adaptive bitrate (ABR) package received from a content provider. The switch points may also indicate optimal opportunities to display messages such as alerts, notifications, or reminders. The switch points are indicative of points in the content that are less likely to interrupt the viewing experience of a user.

### BRIEF DESCRIPTION OF THE DRAWINGS

The following drawings show generally, by way of example, but not by way of limitation, various examples discussed in the present disclosure. In the drawings:

FIG. 1 shows an example system;

FIG. 2 shows an example of bit rate switch points;

FIG. 3 shows an example method;

FIG. 4 shows an example method;

FIG. 5 shows an example method;

FIG. 6 shows an example method; and

FIG. 7 depicts an example computing device.

### DETAILED DESCRIPTION OF ILLUSTRATIVE EMBODIMENTS

Systems and methods are described herein for processing content. The content may comprise video. The embodiments described herein relate to ABR streaming and identifying the best points within content to switch between bitrates. An ABR transcoder encodes an uncompressed or compressed video input stream into multiple streams at different bitrates. A computing device may monitor its network quality along with the amount of content buffered. When network conditions change, the computing device streaming content may decide to switch from one stream to another stream in order to accommodate the changing network conditions. For example, when less network bandwidth is available, the computing device may switch to a stream with a lower bitrate. The terms shift and switch may be used interchangeably herein.

A determination is made to shift the bitrate up or down, the computing device may start buffering the next bitrate. The timing of the buffering (e.g., immediately upon detecting an opportunity, delayed until approaching a switch point, etc.) may be left open to the implementation. Once enough has been buffered, it may immediately shift. Immediate changes in video bitrate, whether to a lower or higher quality bitrate, may disrupt and negatively impact the viewing experience of a viewer. The techniques described herein perform bitrate switches at times when they are less likely to interrupt the viewing experience of a user.

In accordance with the embodiments described herein, switch points may be identified in the content. The switch points may be determined at dark/black or low action points in a scene. For example, the switch points may be associated with a transition between scenes or a transition to or from an ad break. The bitrate switch points may comprise markers for when a change in quality, transition, or interruption will be less noticeable to the user. In the case of an interruption, the switch points may comprise good pause point in the content where the user can take a break. The switch points may comprise good opportunities to make adjustments to the configuration or settings of the computing device such as adjusting the volume. Notifications, alerts, or messages may also be displayed to the user at the switch points. For example, at a switch point, the user may be asked “Are you still watching?” In another example, an alert such as “A show you set a reminder for is about to start” may be displayed. These would provide additional techniques in which switch points could improve the quality of a viewing experience and minimize disruption during viewing.

A computing device streaming content may play back the stream and may determine when a bitrate switch can occur. The computing device may execute an application and/or algorithm that determines the best points within content to switch between ABR bitrates. Further, this application and/or algorithm may be based on a configuration stored on the computing device. For example, the computing device may playback streamed content and used its configured bitrate algorithm/setting to determine when a bitrate switch can occur. When the computing device has determined that there is an opportunity to switch bitrates, instead of immediately beginning to buffer the content, the computing device may queue that decision. The opportunity may be based on a time duration. For example, the system may provide a static allowance for the opportunity such that the opportunity is available for a defined static allowance of time (e.g., 10 seconds). In another example, the opportunity may be dynamic such that if network conditions remain stable, the opportunity to switch bitrates remains available.

The computing device may continue playback as normal and monitor the stream for a switch point. If conditions change during playback, the player can update its decision to switch up or down or remove it from the queue. When a switch point is detected and the point in content approaches switch point, the computing device may begin buffering content for its next bitrate decision. Upon reaching the switch point, the computing device may switch to the newly buffered content.

The computing device may switch bitrates at points in the content that are outside of the switch points. For example, when the computing device detects an imminent event that would negatively impact the viewing experience, such as a buffer that is nearly depleted due to poor network conditions and will soon stall playback to buffer, the computing device may perform the queued bitrate switch instead of waiting for a switch point. Similarly, if the player has made a decision to shift to a higher quality bitrate, to prevent a user from viewing lower quality content when there are few or far spread out switch points, after some delay the computing device may perform the queued bitrate switch.

The switch point may be identified by an encoded location in the content or by data associated with the content. For example, the switch point may be communicated through in-band and out of band timed metadata. For example, the switch point may be indicated by a tag inserted in the encoded content. The tags may be inserted at locations corresponding to the switch points. The tags may be inserted during encoding and packaging of the content. Other forms of time metadata may also be used (e.g., a sidecar file or Web VTT). If a bitrate change is needed during playback of the content, the system may wait to switch bit rates until the next switch point. The tags may comprise out-of-band tags. The out-of-band tags may comprise, for example, HTTP Live Streaming (HLS) tags or Dynamic Adaptive Streaming over HTTP (DASH) events, or any other way to express timed metadata in those formats may be used. Alternatively, the tags may comprise in-band tags. The in-band tags may comprise, for example, ID3 tags. The tags may signal ideal points for the player to switch bitrates.

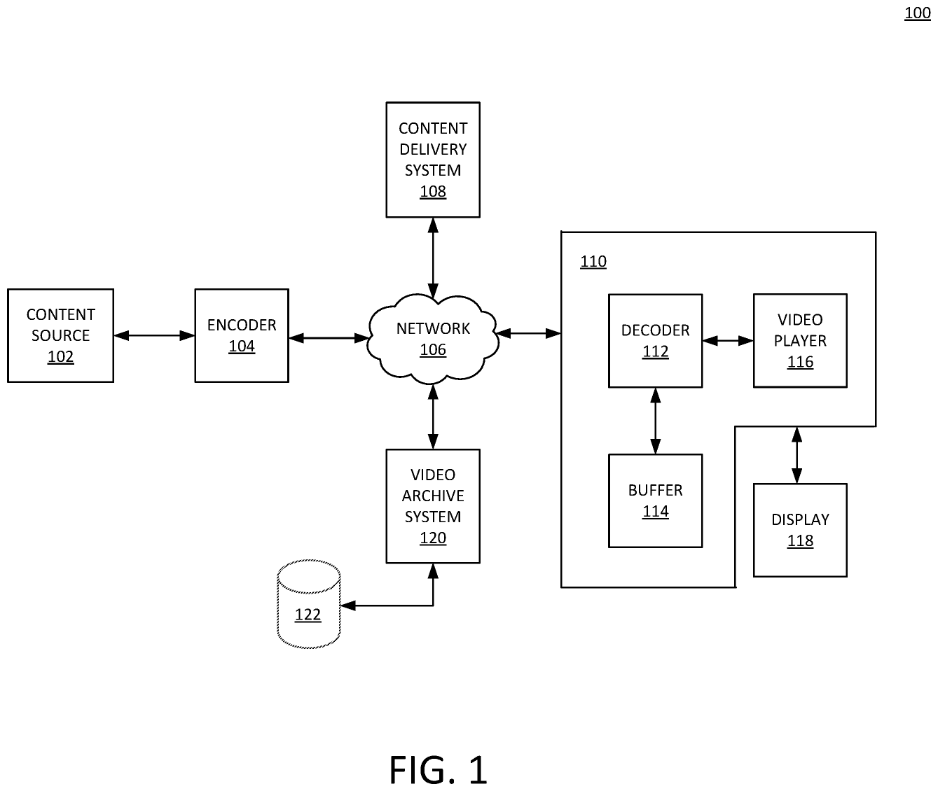

FIG. 1 shows a system 100 configured for video processing. The system 100 may comprise a content source 102, an encoder 104, a content delivery system 108, a computing device 110, and a video archive system 120. The video archive system 120 may be communicatively connected to a database 122 to store archived video data.

The content source 102, the encoder 104, the content delivery system 108, the computing device 110, the video archive system 120, and/or any other component of the system 100 may be interconnected via a network 106. The network 106 may comprise a wired network, a wireless network, or any combination thereof. The network 106 may comprise a public network, such as the Internet. The network 106 may comprise a private network, such as a content provider's distribution system. The network 106 may communicate using technologies such as WLAN technology based on the Institute of Electrical and Electronics Engineers (IEEE) 802.11 standard, wireless cellular technology, Bluetooth, coaxial cable, Ethernet, fiber optics, microwave, satellite, Public Switched Telephone Network (PTSN), Digital Subscriber Line (DSL), BPL, or any other appropriate technologies.

The content source 102 may comprise a headend, a television or movie studio, a video camera, a video on-demand server, a cable modem termination system, the like, and/or any combination of the foregoing. The content source 102 may provide uncompressed content comprising video data. The video data may comprise a sequence of frames. The video frames may comprise pixels. A pixel may comprise a smallest controllable element of a video frame. A video frame may comprise bits for controlling each associated pixel. A portion of the bits for an associated pixel may control a luma value (e.g., light intensity) of each associated pixel. A portion of the bits for an associated pixel may control one or more chrominance value (e.g., color) of the pixel. The video may be processed by a video codec comprising an encoder and decoder. When video frames are transmitted from one location to another, the encoder may encode the video (e.g., into a compressed format) using a compression technique prior to transmission.

The decoder may receive the compressed video and decode the video (e.g., into a decompressed format). The content source 102 and the encoder 104 may be incorporated as a single device and/or may be co-located at a premises. The content source 102 may provide the uncompressed video data based on a request for the uncompressed video data, such as a request from the encoder 104, the computing device 110, the content delivery system 108, and/or the video archive system 120.

The content delivery system 108 may receive a request for video data from the computing device 110. The content delivery system 108 may authorize/authenticate the request and/or the computing device 110 from which the request originated. The request for video data may comprise a request for a linear video playing on a channel, a video on-demand asset, a website address, a video asset associated with a streaming service, the like, and/or any combination of the foregoing. The content source 102 may transmit the requested video data to the encoder 104.

The encoder 104 may encode (e.g., compress) the video data. Based on the request, the encoder 104 may receive the corresponding uncompressed video data. The encoder 104 may encode the uncompressed video data to generate the requested encoded video data. The embodiments described herein are related to ABR streaming, which as described above, is used to encode a video input stream into multiple streams at different bitrates. Each ABR stream may be referred to herein as a variant. Each variant may comprise one or more segments that each comprise a plurality of frames. The encoder 104 may encode the video in one or more ABR streams or variants. The encoder 104 may encode one or more locations in the content that identify one or more switch points to switch from one ABR stream or variant to another ABR stream or variant. Alternatively, the encoder 104 may encode the content with data associated with the content that identifies the locations within the content for one or more switch points to switch from one ABR stream or variant to another ABR stream or variant. For example, a switch point may be communicated through in-band and out of band timed metadata. For example, the switch point may be indicated by a tag inserted in the encoded content. The tags may be inserted at locations corresponding to the switch points. The tags may be inserted during encoding and packaging of the content by the encoder 104. Other forms of time metadata may also be used (e.g., a sidecar file or Web VTT).

The encoder 104 may transmit the encoded video data to the requesting component, such as the content delivery system 108 or the computing device 110. The content delivery system 108 may transmit the requested encoded video data to the requesting computing device 110. The video archive system 120 may provide a request for encoded video data. The video archive system 120 may provide the request to the encoder 104 and/or the content source 102.

The encoded video data may be provided to the video archive system 120. The video archive system 120 may store (e.g., archive) the encoded video data from the encoder 104. The encoded video data may be stored in the database 122. The stored encoded video data may be maintained for purposes of backup or archive. The stored encoded video data may be stored for later use as “source” video data, to be encoded again and provided for viewer consumption. The stored encoded video data may be provided to the content delivery system 108 based on a request from a computing device 110 for the encoded video data. The video archive system 120 may provide the requested encoded video data to the computing device 110.

The computing device 110 may comprise a decoder 112, a buffer 114, and a video player 116. The computing device 110 (e.g., the video player 116) may be communicatively connected to a display 118. The display 118 may be a separate and discrete component from the computing device 110, such as a television display connected to a set-top box. The display 118 may be integrated with the computing device 110. The decoder 112, the video player 116, the buffer 114, and the display 118 may be realized in a single device, such as a laptop or mobile device. The computing device 110 (and/or the computing device 110 paired with the display 118) may comprise a television, a monitor, a laptop, a desktop, a smart phone, a set-top box, a cable modem, a gateway, a tablet, a wearable computing device, a mobile computing device, any computing device configured to receive and/or playback video, the like, and/or any combination of the foregoing. The decoder 112 may decompress/decode the encoded video data. The encoded video data may be received from the encoder 104. The encoded video data may be received from the content delivery system 108, and/or the video archive system 120. When network conditions change (e.g., changing network bandwidth, channel changes, time shifting, etc.), the computing device 110 may request and decode an ABR segment of a new variant.

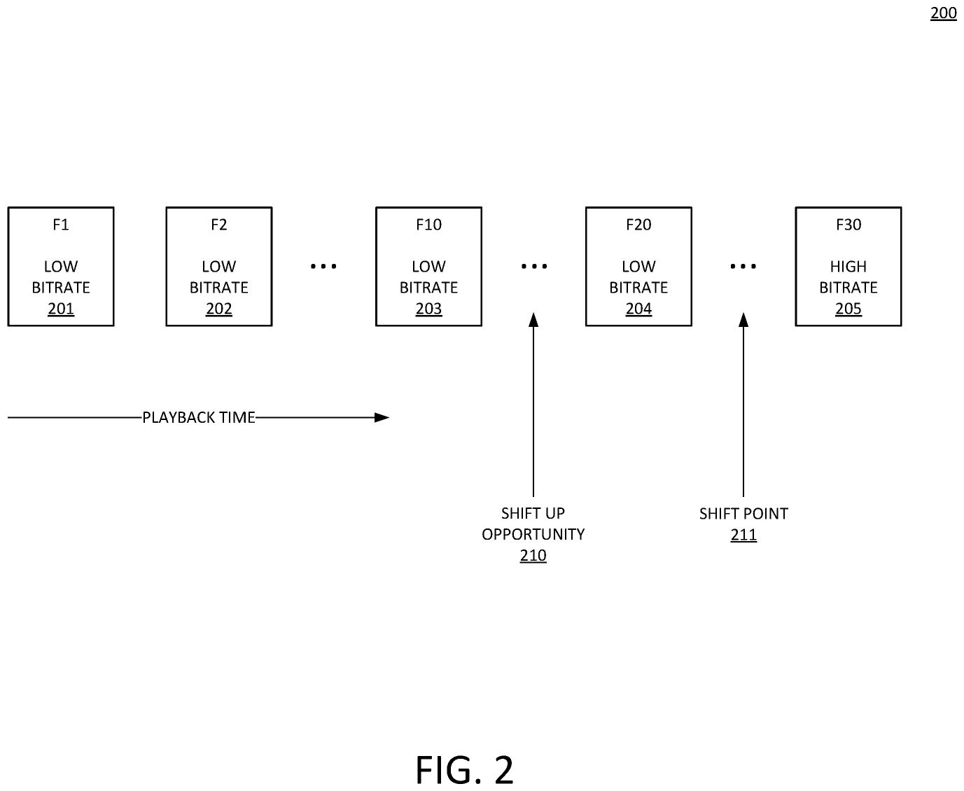

FIG. 2 shows an example of a bit rate switch point 200. The example of FIG. 2 shows a plurality of fragments of a video content stream being played back by a computing device. The plurality of fragments may have an associated low or high bit rate: F1 with a low bitrate 201, F2 with a low bitrate 202, F10 with a low bitrate 203, F20 with a low bitrate 204, and F30 with a high bitrate 205. F1 with the low bitrate 201, F2 with the low bitrate 202, F10 with the low bitrate 203, and F20 with the low bitrate 204 may be associated with a first variant of the content stream encoded at the low bitrate. F30 with the high bitrate 205 may be associated with a second variant of the content stream encoded at the high bitrate.

A computing device, playing back the first variant of the content stream encoded at the low bitrate (comprising F1 with the low bitrate 201, F2 with the low bitrate 202, F10 with the low bitrate 203, F20 with the low bitrate 204) may detect a shift up opportunity 210. The shift up opportunity 210 may be based on improved network bandwidth or more available network bandwidth enabling the computing device to receive larger and/or higher quality fragments of video that were encoded at the high bitrate and have an associated higher quality. When the computing device has determined that there shift up opportunity 210, instead of immediately beginning to buffer the content, the computing device may queue that decision. The opportunity may be based on a time duration. For example, the system may provide a static allowance for the opportunity such that the opportunity is available for a defined static allowance of time (e.g., 10 seconds). In another example, the opportunity may be dynamic such that if network conditions remain stable, the opportunity to switch bitrates remains available. The computing device may buffer content encoded at the higher bitrate and wait to detect a switch or shift point in the content stream.

The computing device may continue playback as normal (e.g., playing back the first variant of the content stream encoded at the low bitrate comprising F1 with the low bitrate 201, F2 with the low bitrate 202, F10 with the low bitrate 203, F20 with the low bitrate 204) and may monitor the stream for a switch point 211. If conditions change during playback, the player can update its decision to switch up based on detection of shift up opportunity 210 or remove it from the queue. When the switch point 211 is detected and the point in content approaches switch point 211, the computing device may begin buffering content for its next bitrate decision. Upon reaching the switch point 211, the computing device may switch to the second variant of the content stream encoded at the high bitrate comprising F30 with the high bitrate 205.

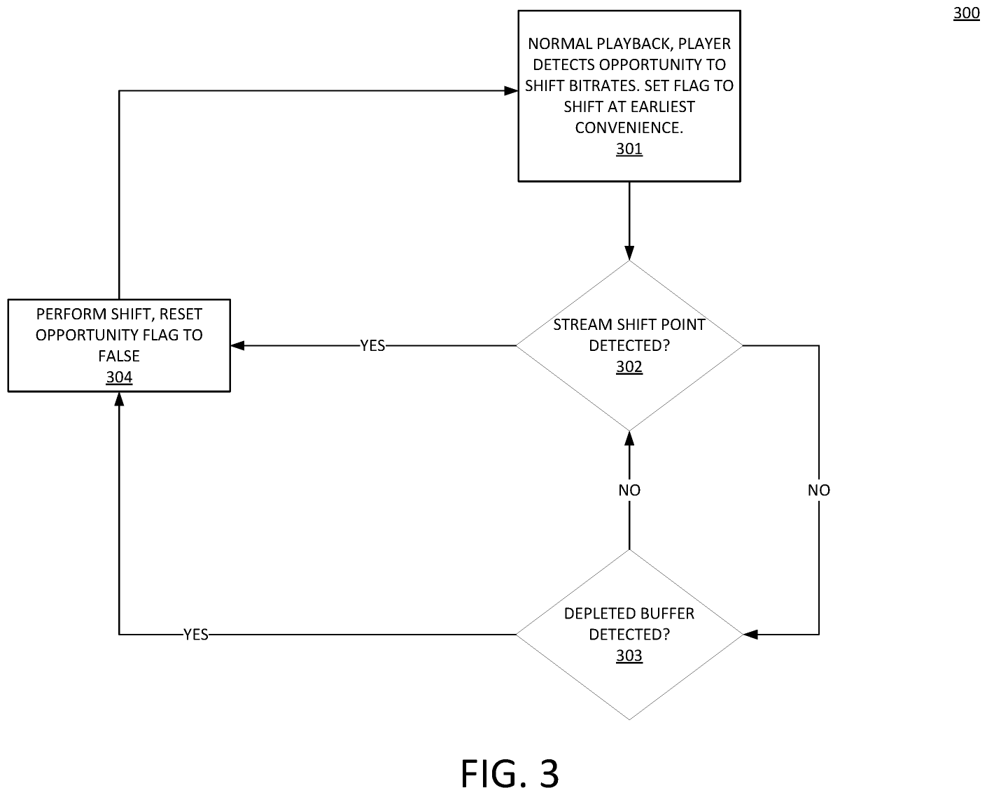

FIG. 3 shows an example method 300. The method 300 of FIG. 3 may be performed, for example, by any of the devices described herein, such as for example the computing device 110 of FIG. 1. While each step in the method 300 of FIG. 3 is shown and described separately, multiple steps may be executed in a different order than what is shown, in parallel with each other, concurrently with each other, or serially with each other. At step 301, a computing device may, during normal playback, detect an opportunity to shift bitrates. For example, the computing device may be playing back a first variant of a content stream encoded at the low bitrate and may detect a shift up opportunity. The shift up opportunity may be based on improved network bandwidth or more available network bandwidth enabling the computing device to receive larger fragments of video that were encoded at the high bitrate and have an associated higher quality. The shift up opportunity may be based on a time duration. For example, the system may provide a static allowance for the opportunity such that the shift up opportunity is available for a defined static allowance of time (e.g., 10 seconds). In another example, the opportunity may be dynamic such that if network conditions remain stable, the shift up opportunity to switch bitrates remains available. When the computing device has determined that the bitrate shift opportunity, instead of immediately beginning to buffer the content, the computing device may queue that decision. For example, an application executing on the computing device and playing back the content may set a flag to indicate that the bitrate shift opportunity was detected. The flag may indicate to the application executing on the computing device and playing back the content to shift bitrates at the earliest convenience.

At step 302, the computing device may determine whether a stream shift point was detected. If at step 302, a stream shift point was detected, at step 304, the computing device may perform the shift. For example, the computing device may shift up to a higher bitrate based on improved network bandwidth or more available network bandwidth and begin receiving larger fragments of video that were encoded at the high bitrate and have an associated higher quality. The application executing on the computing device and playing back the content may reset the shift opportunity flag.

If at step 302, a stream shift point was not detected, at step 303, the computing device may determine the amount of space remaining in its buffer so that it can continue buffering content at the different bitrate. For example, the computing device may determine whether there is space in its buffer to continue buffering content at a higher bitrate in preparation for switching playback to the content at that higher bitrate. If the buffer is nearly depleted, playback may be stalled when switching bitrates. If the buffer is nearly depleted, at step 304, the computing device may perform the shift despite not detecting a shift point in order to cause a transition to the higher bitrate without a stall in playback. The application executing on the computing device and playing back the content may reset the shift opportunity flag. If at step 303, the computing device determines that its buffer is not nearly depleted, the computing device may continue to monitor the content for a shift point at step 302.

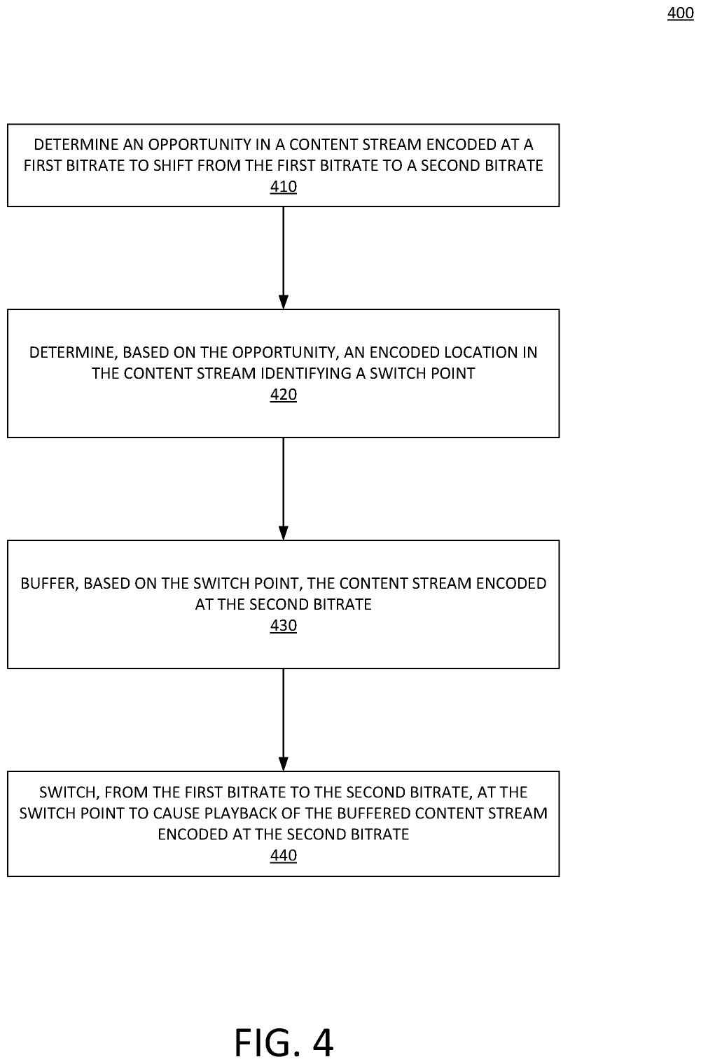

FIG. 4 shows an example method 400. The method 400 of FIG. 4 may be performed, for example, by any of the devices described herein, such as for example the computing device 110 of FIG. 1. While each step in the method 400 of FIG. 4 is shown and described separately, multiple steps may be executed in a different order than what is shown, in parallel with each other, concurrently with each other, or serially with each other. At step 410, a computing device may determine an opportunity in a content stream encoded at a first bitrate to shift from the first bitrate to a second bitrate. The opportunity may be determined, during playback of a content stream encoded at a first bitrate and based on one or more network conditions. The one or more network conditions may comprise at least one of: a change to network bandwidth, a change to a channel being played back, a selection of a time shifting operation, or an amount of the content that has been buffered.

At step 420, the computing device may determine, based on the opportunity, an encoded location in the content stream that identifies a switch point. The switch point may be associated with a low action point or a dark point in a scene within the content. The low action point may indicate a point within the scene with a low quantity of movement. The low action point may indicate a scene change. The dark point may indicate a point within the scene with dim coloring. The switch point may be indicated by a tag that was inserted during encoding of the content. The tag may comprise at least one of: an in-band tag or an out-of-band tag. The in-band tag may comprise an ID3 tag. The out-of-band tag may comprise an HLS tag or a DASH event.

At step 430, the computing device may buffer, based on determining the switch point, the content stream encoded at the second bitrate. At step 440, the computing device may switch, from the first bitrate to the second bitrate, at the switch point to cause playback of the buffered content stream encoded at the second bitrate. The computing device may cause display of one or more messages, wherein the one or more messages comprise at least one of: an alert, a notification, or a reminder.

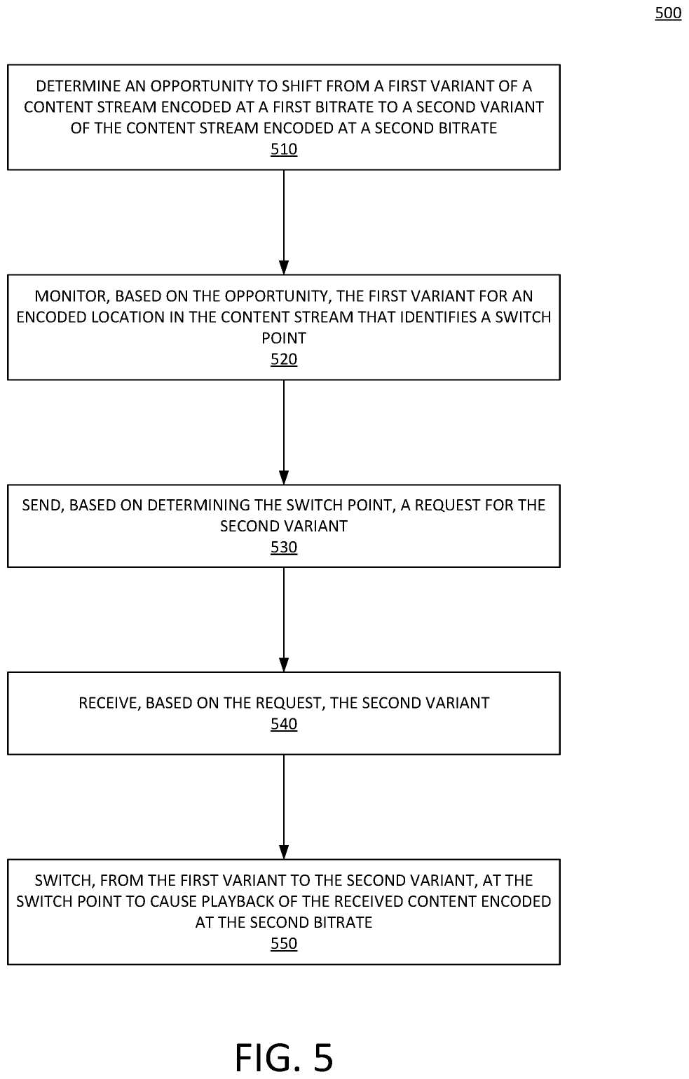

FIG. 5 shows an example method 500. The method 500 of FIG. 5 may be performed, for example, by any of the devices described herein, such as for example the computing device 110 of FIG. 1. While each step in the method 500 of FIG. 5 is shown and described separately, multiple steps may be executed in a different order than what is shown, in parallel with each other, concurrently with each other, or serially with each other. At step 510, a computing device may determine an opportunity to shift from a first variant of a content stream encoded at a first bitrate to a second variant of the content stream encoded at a second bitrate. The opportunity may be determined, during playback of the first variant and based on one or more network conditions. The one or more network conditions may comprise at least one of: a change to network bandwidth, a change to a channel being played back, a selection of a time shifting operation, or an amount of the content that has been buffered.

At step 520, the computing device may monitor, based on the opportunity, the first variant for an encoded location in the content stream that identifies a switch point. The switch point may be associated with a low action point or a dark point in a scene within the content stream. The low action point may indicate a point within the scene with a low quantity of movement. The dark point may indicate a point within the scene with dim coloring. The switch point may be indicated by a tag that was inserted during encoding of the content. The tag may comprise at least one of: an in-band tag or an out-of-band tag. The in-band tag may comprise an ID3 tag. The out-of-band tag may comprise an HLS tag or a DASH event.

At step 530, the computing device may send, based on determining the switch point, a request for the second variant. At step 540, the computing device may receive, based on the request, the second variant. At step 550, the computing device may switch, from the first variant to the second variant, at the switch point to cause playback of the received content stream encoded at the second bitrate. The computing device may cause display of one or more messages, wherein the one or more messages comprise at least one of: an alert, a notification, or a reminder.

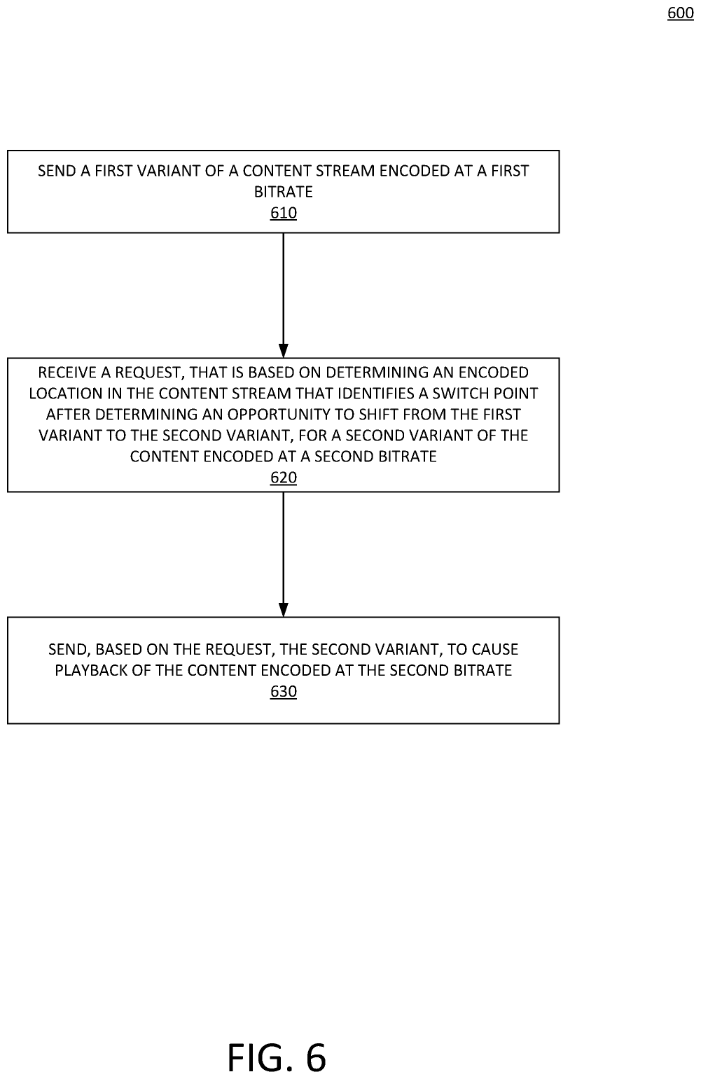

FIG. 6 shows an example method 600. The method 600 of FIG. 6 may be performed, for example, by any of the devices described herein, such as for example the encoder 104, the computing device 110, the content delivery system 108, or the content source 102 of FIG. 1. While each step in the method 600 of FIG. 6 is shown and described separately, multiple steps may be executed in a different order than what is shown, in parallel with each other, concurrently with each other, or serially with each other. At step 610, a first variant of content stream encoded at a first bitrate may be sent to a computing device.

At step 620, a request for a second variant of the content may be received. The request may be based on determining an encoded location in the content stream that identifies a switch point after determining an opportunity to shift from the first variant to the second variant. The second variant may be encoded at a second bitrate.

The switch point may be associated with a low action point or a dark point in a scene within the content. The low action point may indicate a point within the scene with a low quantity of movement. The dark point may indicate a point within the scene with dim coloring. The switch point may be indicated by a tag that was inserted during encoding of the content. The tag may comprise at least one of: an in-band tag or an out-of-band tag. The in-band tag may comprise an ID3 tag. The out-of-band tag may comprise an HLS tag or a DASH event. At step 630, the second variant may be sent, based on the request, to cause playback of the content encoded at the second bitrate.

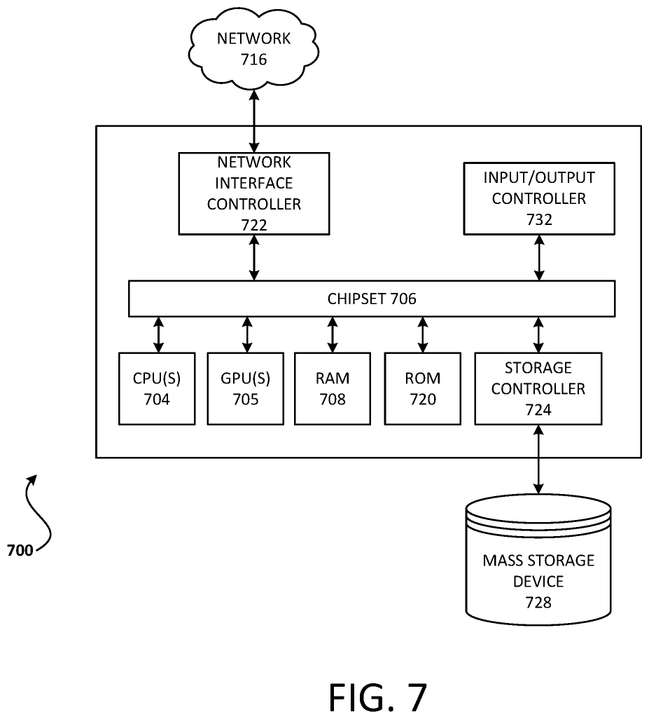

FIG. 7 depicts a computing device 700 that may be used in various aspects, such as the servers, encoders, computing device, and other devices depicted in FIG. 1. With regard to the example architectures of FIG. 1, the devices may each be implemented in an instance of a computing device 700 of FIG. 7. The computer architecture shown in FIG. 7 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIGS. 2-5.

The computing device 700 may include a baseboard, or “motherboard,” which is a printed circuit board to which a multitude of components or devices may be connected by way of a system bus or other electrical communication paths. One or more central processing units (CPUs) 704 may operate in conjunction with a chipset 706. The CPU(s) 704 may be standard programmable processors that perform arithmetic and logical operations necessary for the operation of the computing device 700.

The CPU(s) 704 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 704 may be augmented with or replaced by other processing units, such as GPU(s) 705. The GPU(s) 705 may comprise processing units specialized for but not necessarily limited to highly parallel computations, such as graphics and other visualization-related processing.

A chipset 706 may provide an interface between the CPU(s) 704 and the remainder of the components and devices on the baseboard. The chipset 706 may provide an interface to a random access memory (RAM) 708 used as the main memory in the computing device 700. The chipset 706 may further provide an interface to a computer-readable storage medium, such as a read-only memory (ROM) 720 or non-volatile RAM (NVRAM) (not shown), for storing basic routines that may help to start up the computing device 700 and to transfer information between the various components and devices. ROM 720 or NVRAM may also store other software components necessary for the operation of the computing device 700 in accordance with the aspects described herein.

The computing device 700 may operate in a networked environment using logical connections to remote computing nodes and computer systems through local area network (LAN) 716. The chipset 706 may include functionality for providing network connectivity through a network interface controller (NIC) 722, such as a gigabit Ethernet adapter. A NIC 722 may be capable of connecting the computing device 700 to other computing nodes over a network 716. It should be appreciated that multiple NICs 722 may be present in the computing device 700, connecting the computing device to other types of networks and remote computer systems.

The computing device 700 may be connected to a mass storage device 728 that provides non-volatile storage for the computer. The mass storage device 728 may store system programs, application programs, other program modules, and data, which have been described in greater detail herein. The mass storage device 728 may be connected to the computing device 700 through a storage controller 724 connected to the chipset 706. The mass storage device 728 may consist of one or more physical storage units. A storage controller 724 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 700 may store data on a mass storage device 728 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 728 is characterized as primary or secondary storage and the like.

For example, the computing device 700 may store information to the mass storage device 728 by issuing instructions through a storage controller 724 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 700 may further read information from the mass storage device 728 by detecting the physical states or characteristics of one or more particular locations within the physical storage units.

In addition to the mass storage device 728 described herein, the computing device 700 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 700.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 728 depicted in FIG. 7, may store an operating system utilized to control the operation of the computing device 700. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 728 may store other system or application programs and data utilized by the computing device 700.

The mass storage device 728 or other computer-readable storage media may also be encoded with computer-executable instructions, which, when loaded into the computing device 700, transforms the computing device from a general-purpose computing system into a special-purpose computer capable of implementing the aspects described herein. These computer-executable instructions transform the computing device 700 by specifying how the CPU(s) 704 transition between states, as described herein. The computing device 700 may have access to computer-readable storage media storing computer-executable instructions, which, when executed by the computing device 700, may perform the methods described in relation to FIGS. 2-5.

A computing device, such as the computing device 700 depicted in FIG. 7, may also include an input/output controller 732 for receiving and processing input from a number of input devices, such as a keyboard, a mouse, a touchpad, a touch screen, an electronic stylus, or other type of input device. Similarly, an input/output controller 732 may provide output to a display, such as a computer monitor, a flat-panel display, a digital projector, a printer, a plotter, or other type of output device. It will be appreciated that the computing device 700 may not include all of the components shown in FIG. 7, may include other components that are not explicitly shown in FIG. 7, or may utilize an architecture completely different than that shown in FIG. 7.

As described herein, a computing device may be a physical computing device, such as the computing device 700 of FIG. 7. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems described herein are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

1. A method comprising:
determining, during playback of a content stream encoded at a first bitrate and based on one or more network conditions, an opportunity to shift from the first bitrate to a second bitrate;
determining, based on the opportunity, an encoded location in the content stream that identifies a switch point, wherein the switch point is associated with a low action point in a scene within the content stream, wherein the opportunity is associated with a time duration to perform a bitrate switch;
buffering, based on the switch point, the content stream encoded at the second bitrate; and
switching, from the first bitrate to the second bitrate, at the switch point to cause playback of the buffered content stream encoded at the second bitrate.

2. The method of claim 1, wherein the one or more network conditions comprise at least one of:
a change to network bandwidth,
a change to a channel being played back,
a selection of a time shifting operation, or
an amount of the content stream that has been buffered.

3. The method of claim 1, wherein the low action point indicates a point within the scene with a low quantity of movement.

4. (canceled)

5. The method of claim 1, wherein a tag, inserted during encoding of the content stream, indicates the switch point.

6. The method of claim 5, wherein the tag comprises at least one of:
an in-band tag, wherein the in-band tag comprises an ID3 tag; or
an out-of-band tag, wherein the out-of-band tag comprises an HTTP Live Streaming (HLS) tag or a Dynamic Adaptive Streaming over HTTP (DASH) event.

7. The method of claim 1, further comprising:
causing display of one or more messages, wherein the one or more messages comprise at least one of: an alert, a notification, or a reminder.

8. A method comprising:
determining, during playback of a first variant of a content stream encoded at a first bitrate and based on one or more network conditions, an opportunity to shift from the first variant to a second variant of the content stream encoded at a second bitrate, and wherein the opportunity is associated with a time duration to perform a bitrate switch;
monitoring, based on the opportunity, the first variant for an encoded location in the content stream that identifies a switch point, wherein the switch point is associated with a dark point in a scene within the content stream;
sending, based on determining the switch point, a request for the second variant;
receiving, based on the request, the second variant; and
switching, from the first variant to the second variant, at the switch point to cause playback of the received content stream encoded at the second bitrate.

9. The method of claim 8, wherein the one or more network conditions comprise at least one of:
a change to network bandwidth,
a change to a channel being played back,
a selection of a time shifting operation, or
an amount of the content stream that has been buffered.

10. (canceled)

11. The method of claim 8, wherein the dark point indicates a point within the scene with dim coloring.

12. The method of claim 8, wherein a tag, inserted during encoding of the content stream, indicates the switch point.

13. The method of claim 12, wherein the tag comprises at least one of:
an in-band tag, wherein the in-band tag comprises an ID3 tag; or
an out-of-band tag, wherein the out-of-band tag comprises an HTTP Live Streaming (HLS) tag or a Dynamic Adaptive Streaming over HTTP (DASH) event.

14. The method of claim 8, further comprising:
causing display of one or more messages, wherein the one or more messages comprise at least one of: an alert, a notification, or a reminder.

15. A method comprising:
sending, to a computing device, a first variant of a content stream encoded at a first bitrate;
receiving, from the computing device, a request for a second variant of the content stream, wherein the request is based on determining an encoded location in the content stream that identifies a switch point after determining an opportunity to shift from the first variant to the second variant, wherein the second variant is encoded at a second bitrate, and wherein the switch point is associated with a low action point in a scene within the content stream, and wherein the opportunity is associated with a time duration to perform a bitrate switch; and
sending, based on the request, the second variant to cause playback of the content stream encoded at the second bitrate.

16. The method of claim 15, wherein the request is further based on one or more network conditions, wherein the one or more network conditions comprise at least one of:
a change to network bandwidth,
a change to a channel being played back,
a selection of a time shifting operation, or
an amount of the content stream that has been buffered.

17. The method of claim 15, wherein the low action point indicates a point within the scene with a low quantity of movement.

18. (canceled)

19. The method of claim 15, wherein a tag, inserted during encoding of the content stream, indicates the switch point.

20. The method of claim 15, further comprising:
causing display of one or more messages, wherein the one or more messages comprise at least one of: an alert, a notification, or a reminder.
